(19) United States
(12) Patent Application Publication
(10) Pub. No.: US 2015/0288301 A1
(43) Pub. Date: Oct. 8, 2015

(54) CONNECTION NETWORK FOR NEMS, HAVING AN IMPROVED ARRANGEMENT

(71) Applicant: COMMISSARIAT A L'ENERGIE ATOMIQUE ET AUX ENERGIES ALTERNATIVES, Paris (FR)

(72) Inventor: Gerard Billiot, St Nazaire Les Eymes (FR)

(73) Assignee: COMMISSARIAT A L'ENERGIE ATOMIQUE ET AUX ENERGIES ALTERNATIVES, Paris (FR)

(21) Appl. No.: 14/437,591

(22) PCT Filed: Oct. 25, 2013
(86) PCT No.: PCT/EP2013/072443

§ 371 Date: Apr. 22, 2015

(30) Foreign Application Priority Data
Oct. 26, 2012 (FR) 12 60216

(51) Int. Cl. H02N 11/00

(52) U.S. Cl. CPC H02N 11/002

(57) ABSTRACT

A NEMS including a network of tracks and/or conducting lines on which symmetric excitation signals are applied, the network having a symmetry about an axis passing through a conducting detection line or track carrying a detection signal from the NEMS, the symmetry of the network and the signal providing a solution to a problem of parasitic capacitances generated between the network and the detection line.

### TECHNICAL FIELD AND PRIOR ART

This application relates to the field of electromechanical systems and more particular NEMS (Nano ElectroMechanical Systems) provided with at least one nanometric sized moving element.

It includes a device to limit or even eliminate the influence of the parasitic capacitances phenomenon on detection made by the NEMS when the moving element(s) of the NEMS is (are) operating at high frequency, in other words at more than 100 kHz and particularly more than 1 MHz.

Existing “Cross-Beam” NEMS devices are provided with a moving element 15 that may be in the form of a beam or a rod that will vibrate or oscillate (FIGS. 1A and 1B).

This moving element 15 is usually formed on a semiconductor on insulator type substrate, and particularly on an SOI (Silicon On Insulator) Substrate including a semiconducting support layer 10 that may for example be based on silicon, a so-called “buried oxide” insulating layer 11 that may for example be made of SiO₂ and a thin semiconducting layer 12 that may also be based on Si (FIG. 2).

The moving element 15 is moved by electrostatic actuation means comprising a connection network onto which an excitation signal is applied, the connection network terminating with one or several pads 21, 22 arranged close to the moving element 15.

The excitation signal is usually a high frequency signal or a signal with a frequency of more than 10 kHz.

Detection means including piezo-resistive gauges 26, 27 and a pad 28 are used to detect an electrical signal generated by movements of the moving element 15.

The device also includes piezoelectric gauge polarisation means provided with pads 24, 25, onto which a polarisation signal is applied, usually in the form of a DC voltage.

According to one possible embodiment, the pads 21, 22, 24, 25, 28 may be made in a single metallic level on the substrate. This metallic level may also be used to form an access network (not shown in FIGS. 1A-1B and 2) between pads 21, 22, 24, 25, 28 in the NEMS device and the external connection pads.

Due to the presence of the insulating layer 11, the access network and the pads may generate parasitic capacitances Cp₁, Cp₂, Cp₃, Cp₄, Cp₅, Cp₆ (FIG. 2). The values of these parasitic capacitances Cp₁, Cp₂, Cp₃, Cp₄, Cp₅, and Cp₆ may for example be as high as 1 to 10 pF.

In FIG. 3, a first curve C₁ shows a frequency response of a NEMS device like that described above for an excitation signal between 10 kHz and 100 MHz applied directly to the excitation pad 21 without passing through an access network. In this example, the frequency response comprises a resonant peak at about 20 MHz.

A second curve C₂ shows the frequency response of the device for the same excitation signal, this time applied through an access network. There is no resonant peak on this second curve C₂ due to the parasitic capacitances induced by the access network, and the useful signal is then invisible.

Document U.S. Pat. No. 7,615,845 discloses a method for reducing the parasitic capacitance induced in a MEMS device. This method requires to provide an amplifier and the implementation of a manufacturing process in which several implantations are used to make junctions.

The problem arises of making a new NEMS device in which the impact of parasitic capacitances would be reduced or eliminated.

### PRESENTATION OF THE INVENTION

This invention relates to a device connected to an electromechanical system comprising a moving element, the device comprising at least one first electrical excitation circuit formed from one or several conducting tracks through which at least one first signal transits for excitation of said moving element of the electromechanical system, and at least one second electrical excitation circuit composed of one or several conducting tracks through which at least a second signal transits for excitation of said moving element of the electromechanical system in opposition with said first signal, the first excitation signal, the layout and the shape of the conducting tracks through which this first signal passes, the second excitation signal and the layout and shape of the conducting tracks through which this second signal passes being designed such that the effect of parasitic capacitances between the first circuit and this conducting detection zone over a conducting detection zone that will route the signals representing movements of said moving element of said electromechanical system, is compensated by the effect of parasitic capacitances between said second electrical circuit and the same conducting detection circuit, in this same conducting detection zone.

This invention further relates to a device provided with an electromechanical system formed on a substrate and isolated from the substrate by an insulating layer comprising a moving element actuated by actuation means comprising a first excitation pad located close to said moving element, the first excitation pad being connected to a first conducting track to which a first excitation signal is applied or will be applied, and including a conducting detection zone connected to detection means that will convert the movement of said moving element into an electrical signal, the device further comprising a second conducting track comprising a first end through which the second signal is applied or will be applied, and a second free end, the first and the second conducting tracks being located on opposite sides of said conducting detection zone, the conducting detection zone being connected electrically to the first and second conducting tracks through the first and second parasitic coupling networks respectively through the substrate and the insulating layer, the amplitudes and phase shifts of said first and second excitation signals being predetermined such that the corresponding variations induced by the coupling networks on the signal passing through the conducting detection zone are opposite and compensate each other.

According to one possible embodiment, the second conducting track may include at least one zone symmetric with the first conducting track about a given axis parallel to the substrate. This given axis of symmetry passes through and is parallel to a conducting detection zone connected to detection means capable of converting movements of the moving element into an electrical signal.

The first signal and the second signal may be symmetric signals. Thus, the first signal and the second signal may have the same or approximately the same amplitude, the same frequency and may be in phase opposition or approximately in phase opposition.

A layout or symmetric topology of conducting tracks in the network of NEMS connections carrying excitation signals can make this electromechanical system operate in different excitation modes while limiting the influence of parasitic capacitances on detection.

The influence of parasitic capacitances on an electromechanical device is particularly important when the frequency at which the moving element oscillates or vibrates is high and when this element is small.

The second conducting track acts as a dummy track through which the second excitation signal circulates without actuating the moving element or having any influence on actuation of the moving element, but which due to its behaviour symmetric to the behaviour of the first track can limit the parasitic capacitances phenomenon because of the signal applied to it.

The electromechanical system may be a NEMS provided with a mobile element with a critical dimension that is nanometric or is less than 1 μm.

The first signal and the second signal may for example be signals with a frequency of more than 100 kHz, and particularly sinusoidal signals with a frequency equal to the resonant frequency Fr of the moving element, equal to half the resonant frequency Fr of the moving element.

The first conducting track may include a first conducting portion and a second conducting portion, the critical dimension and length of the first conducting portion being greater than those of said second portion.

The second conducting track may comprise a first conducting portion and a second conducting portion, the critical dimension and length of the first conducting portion being greater than those of said second portion. The first track and the second track may be designed so that the first portion of said first track is symmetric with said first portion of the second track.

Thus, the conducting portions of the first conducting track and the second conducting track with the largest dimensions are made symmetric, the remaining portions of the first conducting track and the second conducting track may possibly be not entirely or perfectly symmetric.

The device may further comprise a third conducting track to which an excitation signal is applied or will be applied, and a fourth conducting track to which another excitation signal is applied or will be applied, at least one zone of the fourth conducting track being symmetric with the third conducting track about said given axis, said fourth conducting track being connected to said second pad, said third conducting track comprising a free end.

According to one possible embodiment, at least one zone of the fourth conducting track may be symmetric with the third conducting track about said axis.

The addition of other conducting tracks can make it possible to implement an excitation mode through which a better gain and a better signal to noise ratio are obtained.

Thus, the fourth conducting track may be connected through a conducting zone to a pad belonging to the actuation means and located close to said moving element, while the fourth conducting track and the first pad are not connected to each other.

A third excitation signal and a fourth excitation signal may be applied to said third conducting track and to said fourth conducting track respectively, the third excitation signal and the fourth excitation signal being in phase opposition.

According to one possible excitation mode of the moving element, the first signal and the third signal may be in phase, while the second signal and the fourth signal are in phase.

According to a second possible excitation mode of the moving element, the first signal and the third signal may be in phase quadrature, while the second signal and the fourth signal are in phase quadrature.

The device may further include means of producing said excitation signals.

The device may further include detection means to convert movements of the moving element into electrical signals.

According to one possible embodiment, the device may include polarisation means, said polarisation means including at least one conducting track to which a polarisation signal is applied or will be applied, and at least one other conducting track to which a polarisation signal is applied or will be applied, said conducting tracks of the polarisation means being symmetric about said axis.

The conducting tracks of the polarisation means may be symmetric about said given axis.

Thus, a symmetry may further be implemented in the conducting tracks that will carry the polarisation signals, to reduce the influence of parasitic capacitances.

The device disclosed above may form part of a matrix device comprising:
at least one row of NEMS,
a first set of conducting zones reproducing the layout of at least several of said conducting tracks of said device as defined above,
a second set of conducting zones with a layout identical to the layout of said first set of conducting tracks,

the first set of conducting zones and the second set of conducting zones being arranged on each side of said row of NEMS in order to surround this row.

The first set of conducting zones, said second set of conducting tracks and said NEMS in said row may be arranged at a uniform pitch.

Such a layout can also limit coupling phenomena induced by two adjacent NEMS.

### BRIEF DESCRIPTION OF THE DRAWINGS

This invention will be better understood after reading the example embodiments given purely for information and that are in no way limitative, with reference to the appended drawings in which:

FIGS. 1A and 1B show a NEMS device with electrostatic excitation and piezo-resistive detection;

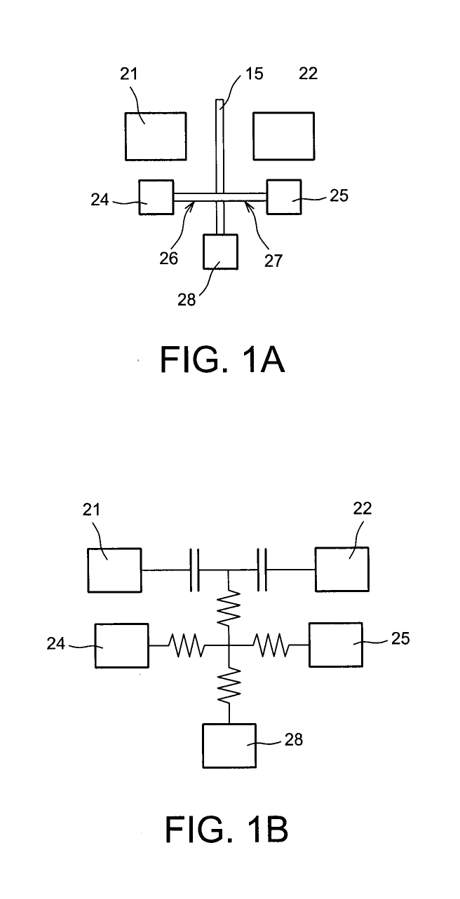

FIG. 2 shows the problem of parasitic capacitances at the connection network of a NEMS device;

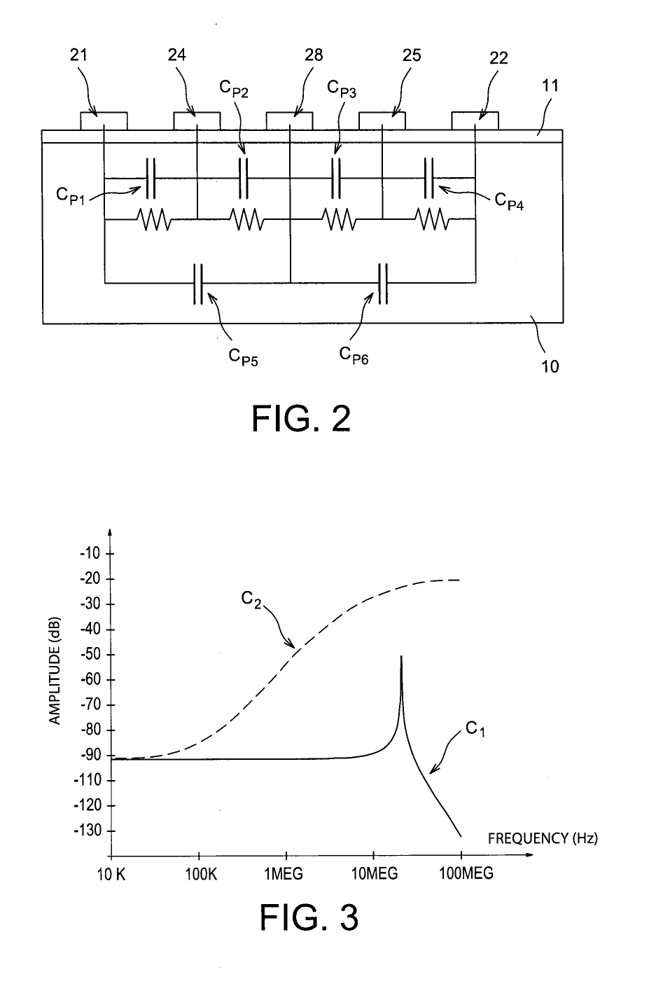

FIG. 3 gives frequency response curves for a NEMS device used according to prior art showing the influence of parasitic capacitances on this device;

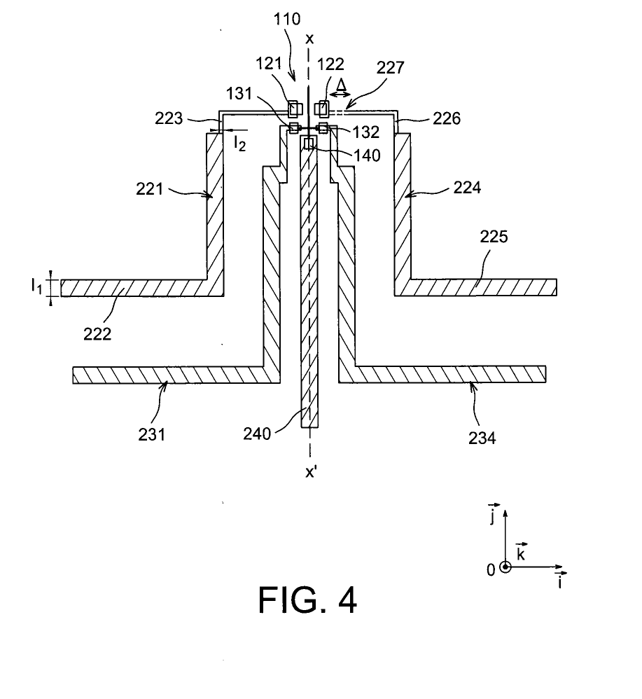

FIGS. 4 and 5 show a first example layout of conducting tracks at a NEMS device according to the invention;

FIG. 6 gives the frequency response curves of a NEMS device used according to one example embodiment of the invention and shows the reduction in the influence of the parasitic capacitances on this device;

FIGS. 7 and 8 show a second example layout of conducting tracks at a NEMS device according to the invention;

FIG. 9 shows a matrix layout in which a row of NEMS is surrounded by dummy conducting tracks on which polarisation and excitation signals are applied,

FIG. 10 shows another example layout of tracks of a NEMS device according to the invention;

Identical, similar or equivalent parts in the different figures have the same numeric references to facilitate comparisons between different figures.

The different parts shown in the figures are not necessarily all at the same scale to make the figures more easily legible.

### DETAILED PRESENTATION OF PARTICULAR EMBODIMENTS

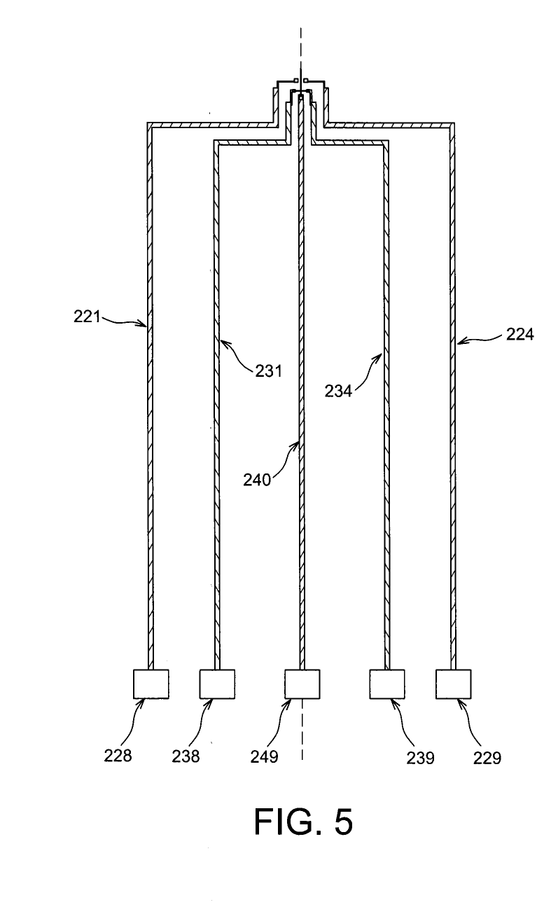

An example of a microelectronic device implemented according to the invention and provided with at least one NEMS will be described with reference to FIGS. 4 and 5.

This device comprises a moving element 110 formed in the thin semiconducting layer of a semiconductor on insulator type substrate, for example of the SOI type, formed from a conducting or semiconducting support layer that may be based on silicon, an insulating layer that may for example be based on silicon oxide SiO₂ and the thin semiconducting layer supported on the insulating layer, this thin semiconducting layer possibly for example being based on silicon Si.

The moving element 110 may be in the form of a beam or a rod comprising a free end designed to move, for example by vibrating or oscillating.

The critical dimension of the moving element 110 may be of the order of several nanometres, for example between 50 nanometres and 200 nanometres.

For the purposes of this application, the critical dimension of an element or a zone means the smallest dimension of this element or this zone apart from its thickness (the critical dimension of the moving element 110 being a dimension measured in an [O; \vec{i}; \vec{j}] plane of the [O; \vec{i}; \vec{j}; \vec{k}] orthogonal coordinate system shown in FIG. 4).

The moving element 110 will be moved by actuation means, possibly electrostatic means.

In particular, these actuation means may include a first pad 121 and a second pad 122 arranged on each side of and close to the moving element 110. The pads 121, 122 may be made partially in the thin semiconducting layer of the SOI substrate and possibly covered with a metallic layer. “Proximity” means that these pads are located at a distance of not more than 500 nanometres and for example less than 50 nanometres from the moving element 110.

The first pad 121 is connected to a first conducting track 221 to which a first excitation signal of the element 110 is applied or will be applied. This first conducting track 221 includes a first portion 222 with a given critical dimension I₁, for example between 2 μm and 50 μm, and a second portion 223 with a given critical dimension I₂, such that I₂<I₁ and for example between 0.2 μm and 5 μm.

The first portion 222 may be chosen to have a total length (measured in the [O; \vec{i}; \vec{j}] plane of the orthogonal coordinate system [O; \vec{i}; \vec{j}; \vec{k}] given in FIG. 4) for example between 50 μm and 5 mm and greater than the length of the second portion 223 for which the total length may for example be between 10 μm and 200 μm. Thus, the first portion 222 occupies a larger area than the second portion 223.

The device also includes a second conducting track 224 through which a second signal for excitation of the element 110 will be applied.

The first excitation signal and the second excitation signal are high frequency signals or signals with a frequency of more than 10 kHz or 100 kHz.

This second conducting track 224 includes a first portion 225 with a given critical dimension and a second portion 226 with a critical dimensionless than that of the first portion. The first portion 225 is also longer than the second portion 226 such that the first portion 225 of the second conducting track 224 occupies a larger area than that occupied by the second portion 226 of this second conducting track 224.

The second conducting track 224 comprises a free end and is not connected to the second actuation pad 122 located close to the element 110. Thus, the second excitation signal of the element 110 propagates along the second conducting track 224 but does not reach the second pad 122.

The first portion 222 of the first conducting track 221 is symmetric with the first portion 225 of the second conducting track 224, about an X′X axis shown in FIG. 4 coincident with the central axis of a conducting track 240 connected to a detection device or detection means. Thus, portions 222 and 225 of the conducting tracks that occupy the largest area on the substrate are symmetric about the given X′X axis.

The second portion 223 of the first conducting track 221 comprises a region symmetric about the X′X axis with the second portion 226 of the second conducting track 224. The track 221 is thus symmetric with the conducting track 224 about the X′X axis except for the end of its portion 223, the track 224 having a free end and not extending as far the pad 122.

The pads 122 and 121 are also symmetric about the X′X axis. The second portion 226 of the second conducting track 224 may be separated from the second pad 122 by a distance Δ between I₂ and 10*I₂.

The device also comprises detection means to convert movements of the moving element 110 into an electrical signal.

These detection means may for example be formed from piezo-resistive gauges and a pad 140, the pad being connected to the track 240 through which a detection signal is recovered and then transmitted to a terminal.

The device also includes means of polarising the detection means and particularly piezo-resistive gauges.

These polarisation means include pads 131, 132, to which a polarisation signal is applied, usually in the form of a DC voltage.

The first pad 131 of the polarisation means is connected to a conducting track 231, while the second pad 132 of the polarisation means is connected to a conducting track 234, the tracks 231 and 234 being symmetric to each other about the X′X axis.

Thus, in addition to the symmetry between the conducting track 224 and a zone of the conducting track 221, symmetry about the X′X axis may also be implemented between conducting tracks 231 and 234 in order to limit the influence of parasitic capacitances generated by these tracks.

For this example of a NEMS device, it would be possible to implement a first excitation mode in which a possibly sinusoidal signal with a frequency equal to the resonant frequency Fr of the NEMS is applied to the first pad 121, while the second signal preferably having the same amplitude and same frequency as the first signal and with a phase shift of [symbol] relative to the first signal is applied to the second conducting track 224.

It would also be possible to implement a second excitation mode in which a possibly sinusoidal signal with a frequency equal to half of the resonant frequency Fr of the NEMS is applied to the first pad 121, while the second signal preferably with the same amplitude and the same frequency (Fr/2) as the first signal and with a phase shift of [symbol] relative to the first signal is applied to the second conducting track 224.

Due to the symmetry between the conducting track 224 and a zone of conducting track 221 about the axis formed by or coincident with the central axis of conducting track 240, and the symmetry of signals applied onto these two conducting tracks 221, 224, the parasitic capacitances effect generated by these conducting tracks 221, 223 and the insulating layer of the substrate on the conducting track 240 and subsequently on the detection signal carried on the conducting track 240 can be eliminated.

FIG. 5 shows the connection network to the NEMS described with reference to FIG. 4. This connection network, also called the “access network”, is connected to actuation pads, polarisation pads and to a NEMS detection gauge.

The layout of the conducting tracks 221, 231, 224, 234 of the access network is similar to that disclosed above, the second conducting track 224 being symmetric with a zone of the first conducting track 221 about an X′X axis passing through a straight track 240 connected to the detection gauge, the conducting tracks 231, 234 also being symmetric about the X′X axis. The conducting tracks 221, 224, terminate at terminals 228, 229 of the access network through which the excitation signals may be delivered by an external device, while tracks 231, 234 terminate at terminals 238, 239 of the access network through which the polarisation signals are applied.

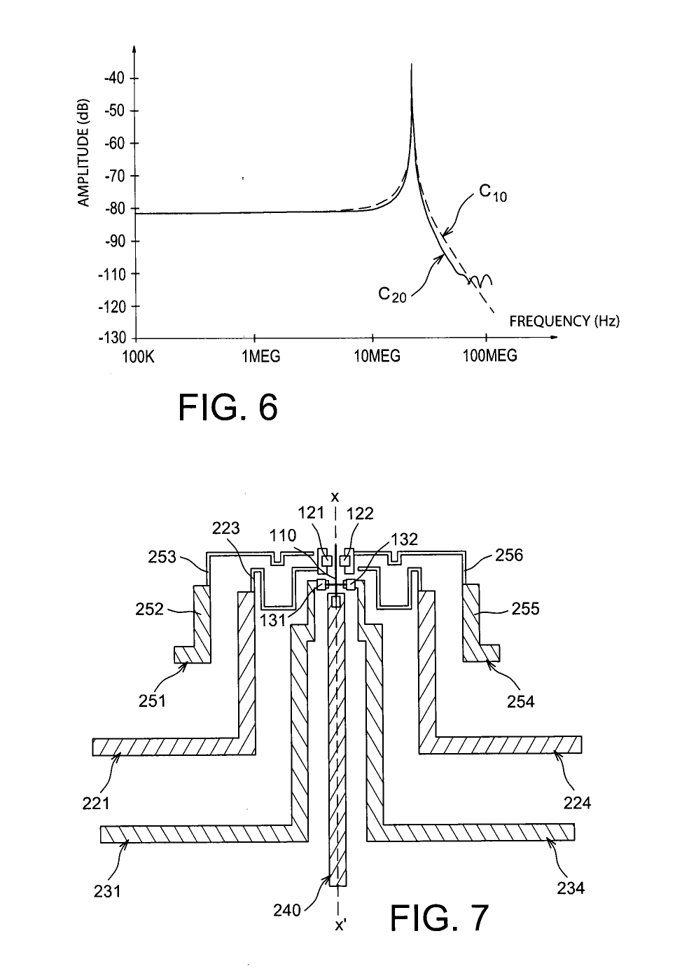

FIG. 6 shows a first curve C₁₀ illustrating a frequency response of a device like that disclosed above with reference to FIG. 4, with an excitation signal of more than 100 kHz applied directly to the excitation terminals without passing through an access network.

A second curve C₂₀ shows the frequency response of the device for the same excitation signal, this time applied through a network of conducting tracks of the type disclosed above with reference to FIGS. 4 and 5.

Due to the symmetry of the access network, whether or not the excitation signals do or do not pass through the access network does not make much difference to the frequency response of the device.

Thus, the influence of parasitic capacitances of the access network has a negligible effect on the frequency response of the NEMS when the layout of the access network is similar to that disclosed above.

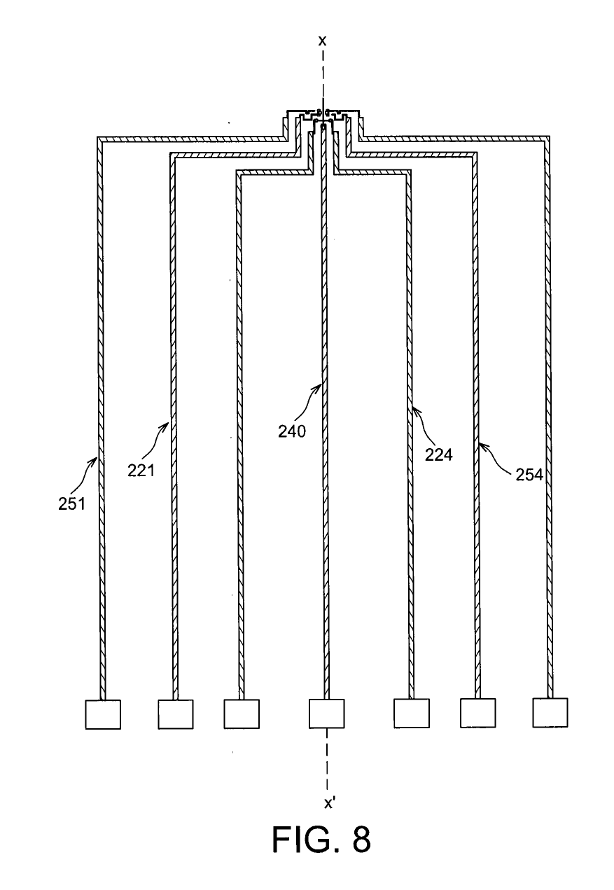

Variant layouts of a device according to the invention are shown on the devices shown in FIGS. 7 and 8 (FIG. 8 showing the connection network of the device in FIG. 7). These variants can give a higher gain and a higher signal-to-noise ratio.

With these variants, additional conducting tracks 251, 254 are provided on each side of the pads 121, 122 located close to the moving element 110.

The actuation means include an additional conducting track 254 to which a signal for excitation of element 110 is or will be applied. This additional conducting track 254 is connected to the second pad 122 and is formed from a first portion 255 and a second portion 256 connected to the second pad 122, the second portion 256 occupying an area smaller than the area of the first portion 255.

The device also includes an additional conducting track 251 through which a signal for excitation of element 110 is or will also be applied. This other conducting track 251 comprises a first portion 252 and a second portion 253 occupying a smaller area on the substrate than the first portion 252.

The additional conducting track 251 comprises a free end that is not connected to the first pad 121, in a manner similar to track 224 and does not participate in actuation of the moving element 110.

The conducting track 254 and the conducting track 251 are symmetric about the X′X axis, passing between pads 121, 122, except for the end of the portion 256 that is not symmetric in that the portion 253 does not extend as far as the pad 121.

Several operating modes may be implemented for these variant layouts.

A first operating mode may be adopted in which a first signal with resonant frequency Fr carried on the first conducting track 221 is applied to the first pad 121 of the NEMS, while a second signal with frequency Fr is applied to the second conducting track 224 at the resonant frequency Fr of the NEMS with a phase shift of [symbol] relative to the first signal.

With this first operating mode, a signal identical to the first signal with frequency Fr can also be applied to the additional conducting track 251 allowed to float while a signal identical to the second signal with frequency Fr with a phase shift of [symbol] relative to the first signal is applied to the additional conducting track 254 connected to the second pad 122.

A second mode may also be provided in which the signals applied to the conducting tracks 221, 224, 251, 254 have a frequency of the order of Fr/2.

In this second mode, a first excitation signal for example with a phase of 0 will be applied to the first pad 121 at a frequency of the order of Fr/2 and a second signal with frequency Fr/2 and a phase shift of [symbol] relative to the first signal is applied to the second conducting track 224.

In this second embodiment, an excitation signal is also applied to the conducting track 251 at a frequency of the order of Fr/2 and a phase of [symbol] /2 or 3 [symbol] /2, and an excitation signal is applied to the conducting track 254 at a frequency of the order of Fr/2 and a phase of 3 [symbol] /2 or [symbol] /2, the excitation signals applied to tracks 251 and 254 having a phase shift of [symbol] .

A NEMS device used according to the invention may possibly have a matrix layout.

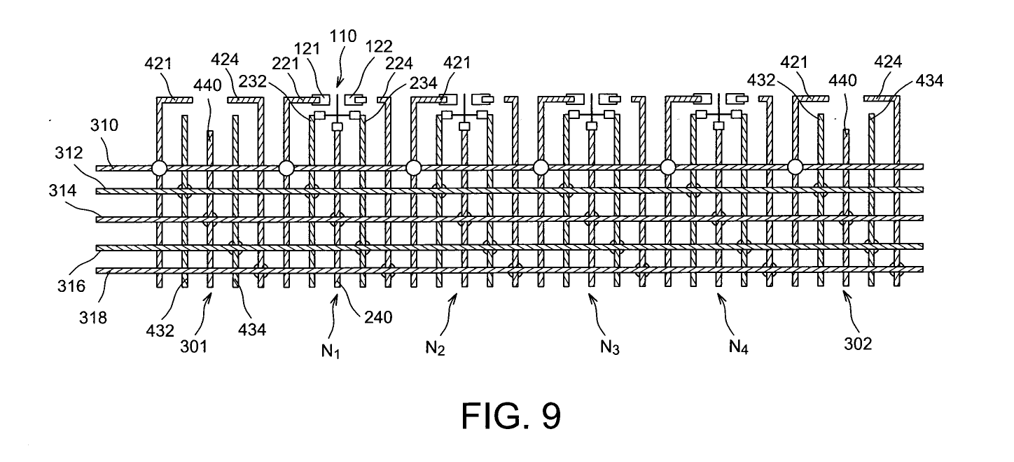

On the device in FIG. 9, a row of several NEMS N₁, N₂, N₃, N₄, for example of the type described with reference to FIGS. 4 and 5, are in line and are each connected to conducting lines 310, 312, 314, 316, 318, of which one conducting line 310 can route the first signal to a first conducting track 221 of the means of actuation of a NEMS, a conducting line 318 transferring the second signal to the second conducting track 224, this second track being symmetric with the first conducting track 221 about the conducting track 240 connected to the detection means of the NEMS and left free without being connected to the actuation means. NEMS N₁, N₂, N₃, N₄ are arranged at a given uniform pitch in said row.

A conducting line 314 shared by NEMS N₁, N₂, N₃, N₄ may be provided to collect detection signals output from their corresponding detection conducting tracks 240 while the conducting lines 312, 316 common to NEMS N₁, N₂, N₃, N₄ are provided to apply polarisation signals to corresponding polarisation conducting tracks 231 and 234 of the NEMS.

The lines 310 and 318 carrying the excitation signals are symmetric about line 314 carrying detection signals output from NEMS N₁, N₂, N₃, N₄.

In this device, a first set 301 of additional conducting tracks left free and a second set 302 of additional conducting tracks left free are arranged on each side of the row of NEMS N₁, N₂, N₃, N₄ respectively.

A first set of conducting tracks 421, 424, 432, 440, 434 at the beginning of the row of NEMS N₁, N₂, N₃, N₄, reproduce the layout and shape of tracks 221, 224, 232, 240, 234 respectively, while a second set 302 of conducting tracks 421, 424, 432, 440, 434 at the end of the row of NEMS N₁, N₂, N₃, N₄, reproduce the layout and the shape of conducting tracks 221, 224, 232, 240, 234 respectively.

The first set 301 and the second set 302 of conducting tracks form dummy connection networks and are also connected to the conducting lines 310, 312, 314, 316, 318, and particularly to conducting lines 310 and 318 designed to carry excitation signals.

Conducting lines 310, 312, 314, 316, 318 may possibly be made in a second metallic level, above the layer in which the conducting tracks 221, 224, 232, 240, 234, 421, 424, 432, 440, 434 are formed.

A given set of tracks of a first NEMS N₁ may for example be surrounded by the first set 301 of dummy tracks and by another set of conducting tracks of a second NEMS N₂, the first set 301 of dummy tracks being symmetric with the other set of conducting tracks of the second NEMS N2 about the detection track 240 of the first NEMS N₁.

Each given set of tracks of a given NEMS is thus surrounded by two sets of tracks symmetric about this set, to compensate for the effects of parasitic capacitances applied to this given NEMS.

The first set 301 and the second set 302 of conducting tracks and the NEMS N₁, N₂, N₃, N₄, are regularly distributed in a line at said given pitch.

This limits the influence of parasitic capacitances created by two adjacent NEMS.

A variant of the matrix layout in FIG. 9 may be considered with a plurality of NEMS as shown in FIG. 7.

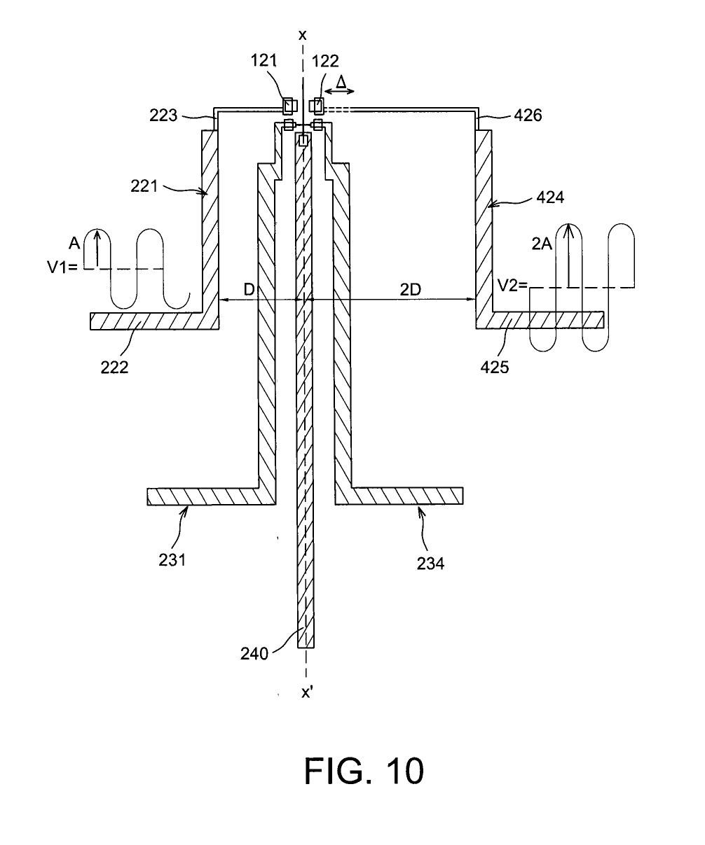

Another example of the device according to the invention will now be described with reference to FIG. 10.

This device is different from the device disclosed above due to the layout of its actuation means. The actuation means include the first pad 121 and the second pad 122 located on each side of the moving element 110 and the first conducting track 221 through which the first signal for excitation of element 110 will be applied.

The device also includes a second conducting track 424.

This second conducting track 424 comprises a first portion 425 and a second portion 426 with critical dimension smaller than the critical dimension of the first portion 425. The first portion 425 is located at a distance 2D from the conducting track 240 connected to the detection means, equal to twice the distance D between the first portion 222 of the first conducting track 221 and this same conducting track 240.

The first signal and the second excitation signal have corresponding amplitudes and phase shifts such that the corresponding variations induced by tracks 221, 424 on the signal passing through the conducting detection zone are opposite and compensate each other.

In the example shown in FIG. 10, the main parasitic elements between tracks 221, 424 and the detection zone 240 are capacitive (there is a capacitance C between tracks 221 and 240, and a capacitance C/2 between tracks 424 and 240). The variations induced by tracks 221,224 on track 240 can thus be compensated by applying a first excitation signal V₁ with amplitude A to the first conducting track 221, and a second excitation signal V₂ with amplitude 2A, 2 twice the amplitude of the first signal, to the second track 424.

If it is required to modify the layout of conducting tracks 221 and 424 to which excitation signals are applied to reduce or eliminate the effects of parasitic elements on the detection signal carried on the conducting track 240, the corresponding amplitudes and phase shifts of excitation signals applied to these conducting tracks are adapted. The parasitic elements may have a variety of natures (capacitive, resistive, etc.), and therefore tests can be carried out with different excitation signals with a variety of amplitudes and phase shifts, in a preliminary adjustment phase before use of the device. These tests may be done on the device after it was manufactured, or before it was manufactured for example by using software simulation tools.

In the example embodiments described above, the device according to the invention is not limited to piezo-resistive detection but may also be applied to capacitive detection means.

The device according to the invention is used particularly for applications in the field of gas detection, and mass variation measurements.

1-16. (canceled)

17. A device comprising:
an electromechanical system formed on a substrate and isolated from the substrate by an insulating layer comprising a moving element actuated by an actuation device comprising a first excitation pad located close to the moving element;
the first excitation pad being connected to a first conducting track to which a first excitation signal is applied or will be applied, and including a conducting detection zone connected to a detection device that converts movement of the moving element into an electrical signal;
a second conducting track comprising a first end through which a second signal is applied, and a second free end, the first and the second conducting tracks being located on opposite sides of the conducting detection zone, the conducting detection zone being connected electrically to the first and second conducting tracks through first and second parasitic coupling networks respectively through the substrate and the insulating layer,
amplitudes and phase shifts of the first and second excitation signals being predetermined such that corresponding variations induced by the first and second excitation signals through the coupling networks on the signal passing through the conducting detection zone are opposite and compensate each other.

18. The device according to claim 17, further comprising at least one second pad located close to the moving element, the second conducting track and the second pad not being connected.

19. The device according to claim 17, the second conducting track comprising at least one zone symmetric with the first conducting track about the conducting detection zone with a given axis parallel to the substrate.

20. The device according to claim 19, the first conducting track comprising a first conducting portion and a second conducting portion, the first conducting portion occupying a greater area on the substrate than that of the second conducting portion, the second conducting track comprising a first conducting portion and a second conducting portion, the first conducting portion occupying a greater area on the substrate than that of the second conducting portion, the first portion of the first track being symmetric with the first portion of the second conducting track about the given axis.

21. The device according to claim 19, the first signal and the second signal being in phase opposition.

22. The device according to claim 17, wherein a second pad is located close to the moving element, the second conducting track and the second pad not being connected, the device further comprising a third conducting track to which an excitation signal is applied, and a fourth conducting track to which a fourth excitation signal is applied, the fourth conducting track being connected to the second pad, the third conducting track comprising a free end.

23. The device according to claim 22, wherein at least one zone of the fourth conducting track is symmetric with the third conducting track about a given axis parallel to the substrate.

24. The device according to claim 22, the third signal and the fourth signal being in phase opposition.

25. The device according to claim 22, the first signal and the third signal being in phase, the second signal and the fourth signal not being in phase.

26. The device according to claim 24, the first signal and the third signal being in phase quadrature, the second signal and the fourth signal being in phase quadrature.

27. The device according to claim 17, further comprising a polarization device, the polarization device comprising at least one conducting track to which a polarization signal is applied and at least one other conducting track to which a polarization signal is applied.

28. The device according to claim 27, wherein the conducting tracks of the polarization device are symmetric about the given axis.

29. The device according to claim 17, further comprising a device for applying the excitation signals to the conducting tracks.

30. The device according to claim 17, wherein the frequency of the excitation signals is more than 100 kHz.

31. The device according to claim 17, wherein the electromechanical system is a nano-electromechanical system (NEMS).

32. A matrix device comprising:
a plurality of devices including electromechanical systems according to claim 17 and being adjacent to each other;
a first and a second set of conducting tracks each reproducing a layout of at least plural of the conducting tracks of one of the plurality of devices, the first set of tracks, the second set of tracks, and the electromechanical devices being arranged in a row and at a given uniform pitch, the first and second sets being located on each side of the plurality of devices.
